(19) United States
(12) Patent Application Publication
(10) Pub. No.: US 2014/0034463 A1
(43) Pub. Date: Feb. 6, 2014

(54) TAP CHANGER AND VACUUM INTERRUPTER FOR A TAP CHANGER OF THIS KIND

(71) Applicant: Astrid Renz, (US)

(72) Inventors: Wolfgang Albrecht, Wenzenbach (DE); Christian Hammer, Regensburg (DE); Werner Hartmann, Weisendorf (DE); Silvio Kosse, Erlangen (DE); Andreas Lawall, Berlin (DE); Roman Renz, Berlin (DE); Andreas Stelzer, Berlin (DE); Joerg Teichmann, Alzenau (DE); Norbert Wenzel, Erlangen (DE)

(21) Appl. No.: 13/878,059

(22) PCT Filed: Nov. 10, 2011
(86) PCT No.: PCT/EP2011/005641

§ 371 Date: Sep. 25, 2013

(30) Foreign Application Priority Data
Nov. 30, 2010 (DE) 10 2010 053 466.8

(51) Int. Cl. H01H 9/00

(52) U.S. Cl. CPC H01H 9/0038
USPC 200/11 TC

(57) ABSTRACT

The invention relates to a tap changer for switching over between winding taps of a tap transformer without interruption, wherein two load branches are provided for each phase which is to be switched and each load branch has a vacuum switching contact, which acts as a main contact and, parallel to said vacuum switching contact, at least one series circuit comprising a transition resistor and in each case a further vacuum switching contact. In this case, in each case one vacuum switching contact of each load branch is structurally combined to form a single vacuum interrupter having two separate, fixed contacts (5, 8), which can be selectively connected, and a single moving contact (4).

The invention relates to a tap changer with vacuum switching tubes for uninterrupted switching over between winding taps of a tapped transformer. The invention further relates to a novel vacuum switching tube particularly suitable for such a tap changer.

A tap changer having in total four vacuum switching tubes per phase is known from DE 20 21 575. Provided in each of the two load branches are a respective vacuum switching tube as main contact and a respective further vacuum switching tube, in series connection with a switch-over resistance, as resistance contact.

In the case of uninterrupted load changeover from the previous winding tap n to a new, preselected winding tap n+1 initially the main contact of the side switching off is opened and is thereupon the resistance contact of the side taking over closes so that a compensating current limited by the switch-over resistors flows between the two taps n and n+1. After the previously closed resistance contact of the side switching off has opened, the main contact of the side taking over then closes so that the entire load current is conducted from the new winding tap n+1 to the load diverter; the changeover is concluded.

A further tap changer in which further mechanical switch elements are additionally provided between the electrical connection of the two vacuum switching tubes of each load branch and the load diverter is described in DE 10 2009 048 813 that is not prior published.

The known tap changer requires four separate vacuum switching tubes per phase. In the first instance, the large amount of space required for these vacuum switching tubes themselves, as well as the associated actuated mechanism is disadvantageous. Moreover, due to the high component outlay such known constructions are relatively expensive.

It is the object of the invention to indicate a tap changer which, for the same functionality, is of simpler construction, in which the switching elements need less space and are, in addition, less expensive.

Moreover, it is an object of the invention to indicate a vacuum switching tube which is usable, with particular advantage, for such a further developed tap changer.

The tap changer according to the invention is based on the general idea of respectively combining the main contact in one load branch and the resistance contact in the other load branch to form a single vacuum switching tube.

Moreover, the vacuum switching tube according to the invention is based on the general idea of combining the functionality of two tubes in a tap changer through the combination of a constructional form of a tube with only one movable contact system and two alternative—depending on the type of changeover switch—contactable fixed contacts. In that case, the novel vacuum switching tube is of simple construction; it does not have, in particular, any internally located contact compression springs or slide contacts. Particularly advantageous in the case of the vacuum switching tube according to the invention is the single movable contact system that occupies less space and requires only a simple actuating mechanism.

Vacuum switching tubes with two contact locations are already known per se.

DE 333443767 relates to a vacuum switching tube with two contact pairs, which are electrically connected in series, in a single vacuum space, the contact pairs being actuatable simultaneously.

DE 197 56 308 C1 relates to a similar vacuum switching tube with two switch paths arranged on a common axis, wherein internally disposed contact compression springs are provided.

EP 0 258 614 B1 describes the combination of a vacuum switching tube and a specific electrical connection with a tap changer. In this case, several switching paths are arranged in one is vacuum space, which causes a complicated construction of the vacuum switching tube with annular fixed contacts.

Finally, DE 10 2006 033 B3 describes a further vacuum switching tube with a multiple functionality, wherein here, too, not only annular fixed contacts, but also internally disposed contact pressure springs are required.

None of these known solutions is suitable for a tap changer according to the invention.

The invention shall be explained in more detail in the following by way of example with reference to drawings, in which:

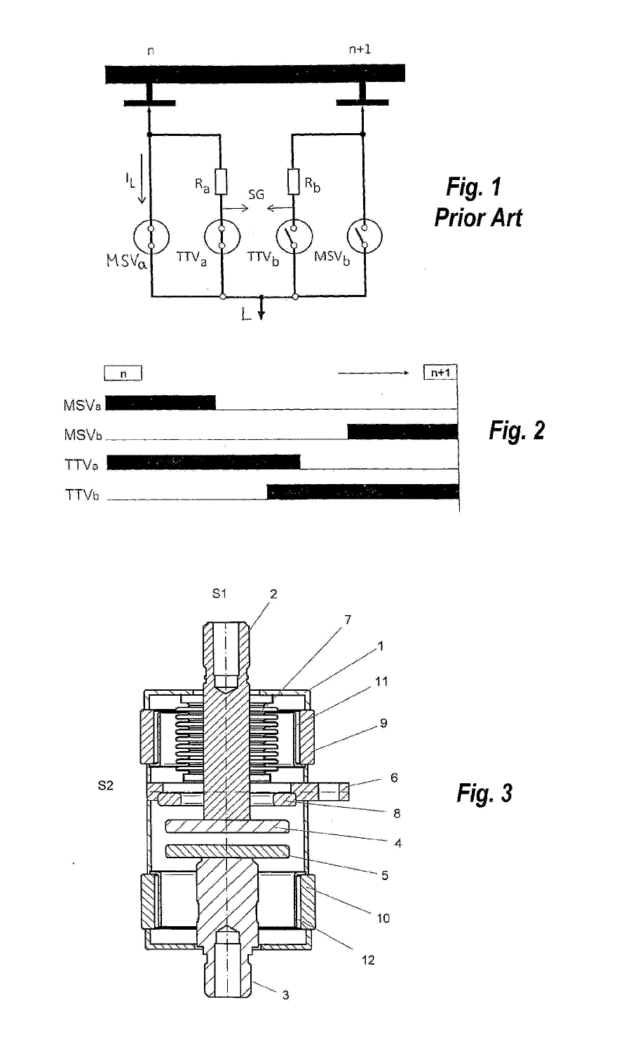

FIG. 1 shows a tap changer according to the prior art,

FIG. 2 shows a changeover sequence of such a known tap changer,

FIG. 3 shows a vacuum switching tube according to the invention,

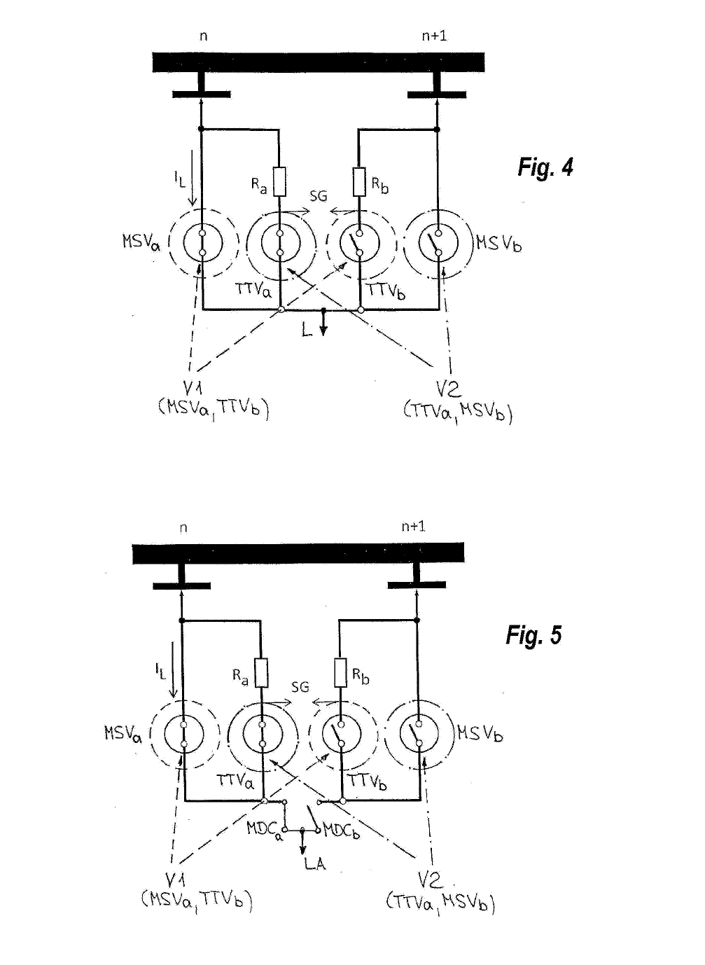

FIG. 4 shows a tap changer according to the invention with two vacuum switching tubes according to the invention in schematic illustration and

FIG. 5 shows a further tap changer according to the invention.

A known tap changer is shown in FIG. 1. It has a first load branch in which a vacuum switching tube MSVₐ acting as a main contact as well as parallel thereto a switch-over resistance Rₐ and a vacuum switching tube TTVₐ acting as a resistance contact are present. In entirely analogous manner, the second load branch comprises a vacuum switching tube MSV_{b} as well as parallel thereto a further switch-over resistance R_{b} and a vacuum switching tube TTV_{b}. The known tap changer thus has two vacuum switching cells per load branch, therefore four vacuum switching cells per phase in total.

FIG. 2 shows the switching sequence of such a known tap changer in the case of changeover from the winding tap n to the winding tap n+1. The starting position, in which the tap n is electrically connected, corresponds with the setting of the individual switching elements illustrated in FIG. 1. The changeover takes place in the following steps:
MSVₐ opens
TTV_{b} closes
TTVₐ opens
MSV_{b} closes;
   the changeover is concluded.

FIG. 3 shows a combined vacuum switching tube according to the invention. In that case a common housing 1 enclosing the entirety of vacuum switching tubes is provided. Provided centrally in the rotationally symmetrical longitudinal axis s1 is an upper movable plunger 2 and, at the opposite end, a lower fixed contact terminal 3. The movable plunger 2 carries a movable contact member at its inner free end. The fixed lower contact terminal 3 carries in its turn a fixed contact member 5. Provided above the movable contact member 4 is an encircling annular stationary contact arrangement 6 that is disposed perpendicularly to the rotationally symmetrical longitudinal axis S1 in the plane S2 that is here illustrated to be horizontal. A fixed contact 8, which is, for example, soldered, is fastened to the contact arrangement 6. The is fixed contact 8 is, in an end setting of the movable plunger 2, electrically connectable by the contact member 4 thereof. In the other end setting this contact member 4 electrically connects the stationary contact member 5 of the lower contact terminal 3. The movable contact member 4 can thus electrically connect, in the manner of a changeover switch, selectably not only the stationary contact 8, but also the stationary contact member 5. Bellows 7 are illustrated as well as upper and lower ceramic members 9, 10, and in the interior of the housing 1 an upper attenuating screen 11 and a lower attenuating screen 12.

Overall, several advantages are achieved with the tap changer according to the invention with vacuum switching tubes according to the invention: The number of vacuum switching tubes necessary is de facto halved; the need for space for these switching elements is correspondingly smaller. Costs similarly reduce. This is achieved by the vacuum switching tube used in accordance with the invention that is constructed as a ‘tandem tube’ and, in particular, contains two separately switching contacts, but only a single movable contact system.

In that case, the vacuum switching tube according to the invention is of simple construction; by contrast to the solutions known from the prior art it needs neither internally disposed contact compression springs nor complicated actuating mechanisms or special cage-like contact constructions.

FIG. 4 shows, in schematic illustration, a tap changer with two load branches, as has already been explained in FIGS. 1 and 2. It can be seen that here, according to the invention, the is vacuum switching tube MSVₐ acting as a main contact, of the first load branch and the vacuum switching tube TTV_{b} acting as a resistance contact, of the second load branch are combined into a first vacuum switching tube V1 according to the invention. Equally, the vacuum switching tube MSVₐ acting as a main contact, of the second load branch and the vacuum switching tube TTV_{b} acting as a resistance contact, of the first load branch are combined into a second vacuum switching tube V2 according to the invention.

This takes place in that in the case of the first vacuum switching tube V1 according to the invention, for example, the contact path between fixed contact member 5 and movable contact member 4 takes over the function of the MSVₐ, whilst the contact path between fixed contact 8 and movable contact member 4 takes over the function of the TTV_{b}. In entirely analogous manner in the case of the second vacuum switching tube V2 according to the invention, for example, the contact path between the fixed contact member 5 and movable contact member 4 takes over the function of the MSV_{b}, whilst the contact path between fixed contact 8 and movable contact member 4 takes over the function of the TTVₐ. Obviously, other electrical connections of the contact paths of the two vacuum switching tubes V1, V2 are also possible within the scope of the invention.

FIG. 5 shows a further tap changer according to the invention, in which additional mechanical switching elements (MDCₐ, MDC_{b}) are provided that serve for electrical insulation of the load branch not conducting the load current.

In all forms of embodiment the advantage of the invention consists in that only two vacuum switching tubes each with only one movable contact member, which is to be driven, are required in order to replace in total four separate contacts in the two load branches.

1. A tap changer for uninterrupted switching over between winding taps of a tapped transformer, wherein
two load branches are provided for each phase to be switched,
each load branch comprises a vacuum switching contact acting as a main contact, and in parallel thereto a series connection of a switch-over resistance and a respective further vacuum switching contact acting as a resistance contact, and to wherein the two load branches are connected with a common load diverter or are connectable by means of mechanical switching elements,
the vacuum switching contact acting as main switching contact, of the first load branch and the vacuum switching contact acting as resistance contact, of the second load branch are constructionally combined to form a single first vacuum switching tube with a movable contact and two fixed contacts selectably connectable by this,
the vacuum switching contact acting as main switching contact, of the second load branch and the vacuum switching contact acting as resistance contact, of the first load branch are constructionally combined to form a single second vacuum switching tube with a movable contact and two fixed contacts selectably connectable by this, and
the movable contacts of the two vacuum switching tubes are connected with the common load diverter or are connectable by means of mechanical switching elements.

2. Use of a vacuum switching tube for a tap changer according to claim 1, wherein
a common housing enclosing the entirety of vacuum switching tubes is provided,
an upper, movable plunger is provided centrally in a rotationally symmetrical longitudinal axis and a lower fixed contact terminal is provided at the opposite end,
the movable plunger carries a movable contact member at its inner free end and the fixed lower contact terminal carries a fixed contact member at its inner free end and a stationary contact arrangement with a further fixed contact is provided at the side of the movable contact member remote from the fixed contact member in such a manner that selectably the fixed contact member or fixed contact is connectable by the movable contact member.

3. The use of a vacuum switching tube according to claim 2, wherein the stationary contact arrangement together with the further fixed contact is disposed perpendicularly to the rotationally symmetrical longitudinal axis in a further plane.

4. The use of a vacuum switching tube according to claim 2, wherein the stationary contact arrangement is constructed as an at least partly encircling annular contact arrangement.
